(19) United States
(12) Patent Application Publication
(10) Pub. No.: US 2013/0233653 A1
(43) Pub. Date: Sep. 12, 2013

(54) ELEVATOR SYSTEM

(71) Applicant: YEN-CHUN CHEN, Tu-Cheng (TW)

(72) Inventor: YEN-CHUN CHEN, Tu-Cheng (TW)

(73) Assignee: HON HAI PRECISION INDUSTRY CO., LTD., Tu-Cheng (TW)

(21) Appl. No.: 13/533,060

(22) Filed: Jun. 26, 2012

(30) Foreign Application Priority Data
Mar. 7, 2012 (TW) 101107723

(51) Int. Cl. B66B 1/20

(52) U.S. Cl. 187/381

(57) ABSTRACT

An elevator system includes a cage, a first capturing device, a second capturing device, and a control module. The cage includes an inner room. The first capturing device is configured for capturing an image of the inner room. The second capturing device is configured for capturing an image of a waiting area outside the cage. The control module receives the images output from the first capturing device and the second capturing device and determines whether or not there is any passenger located at the waiting area and whether or not there is enough room in the inner room to receive the passenger. The control module controls the cage to stop or not to stop according to the determination.

### BACKGROUND

1. Technical Field

The present disclosure relates to elevators and, particularly, to an elevator system.

2. Description of Related Art

Elevators are a type of vertical transport equipment that efficiently moves people or goods between floors of a building, such as residential building or office building. Each floor is provided with a control panel that includes an up and down button. If any one of the up and down buttons of a certain floor is pressed, a cage of the elevator will be driven to go to and stop at that floor, regardless of whether or not the elevator is full or if the people leave after pressing the buttons. As such, efficiency of the elevator is often less than satisfactory.

Therefore, it is desirable to provide an elevator system, which can overcome the limitations described.

### BRIEF DESCRIPTION OF THE DRAWINGS

FIG. 1 is a function block of an elevator system in accordance with an exemplary embodiment.

FIG. 2 is a cross-section view of an elevator of the elevator system of FIG. 1.

### DETAILED DESCRIPTION

Embodiments of the disclosure will be described with reference to the drawings.

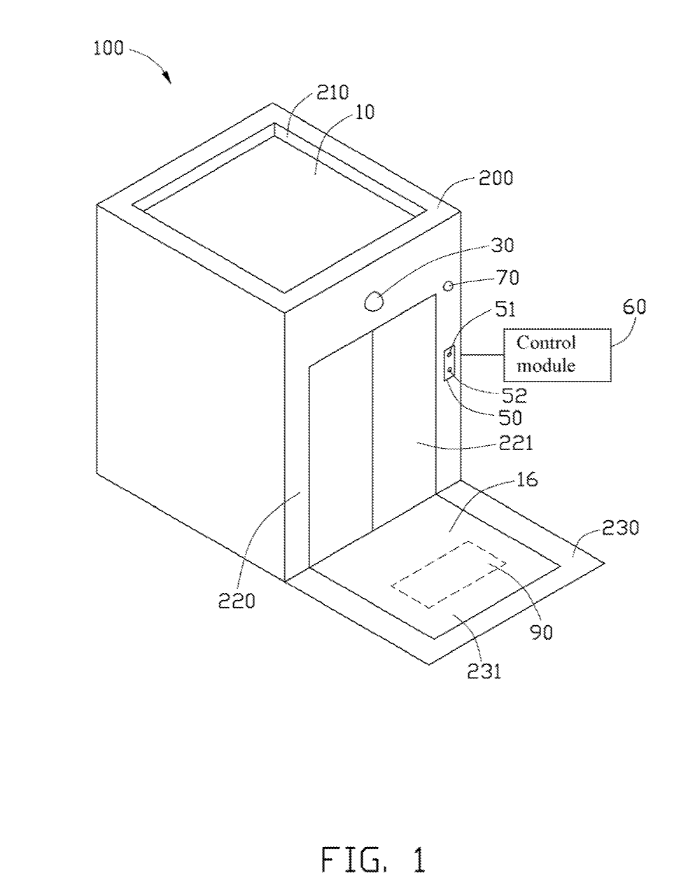

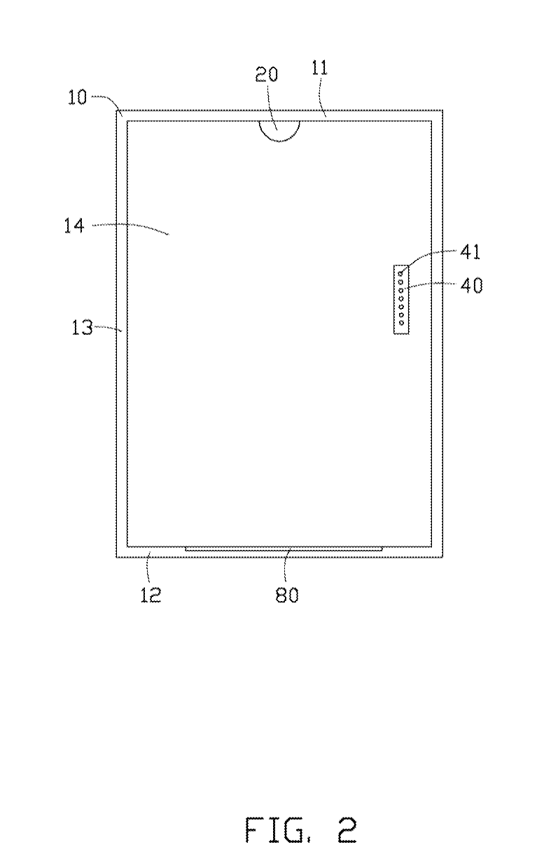

FIGS. 1-2, illustrate an elevator system 100, according to an exemplary embodiment. The elevator system 100 is installed in a shaft 210 of a building 200. The elevator system 100 includes a cage 10, a first capturing device 20, a second capturing device 30, an inner control panel 40, an outer control panel 50, a control module 60, and an alarm device 70.

The building 200 includes a wall 220 and a floor 230 substantially perpendicular to the wall 220. The wall 220 is substantially parallel to a movement direction of the cage 10, and the floor 230 is substantially perpendicular to the movement direction of the cage 10. The wall 220 defines a door 221. The floor 230 defines a waiting area 231 in front of the door 221. People wait for the cage 10 at the waiting area 231 and enter or exit the cage 10 through the door 221.

The cage 10 has a cubic configuration and includes a ceiling 11, a cage floor 12 opposite to the ceiling 11, and a sidewall 13 connected between the ceiling 11 and the cage floor 12. The ceiling 11, the cage floor 12, and the sidewall 13 cooperatively define an inner room 14. The cage 10 is driven by a driving device (not shown), such as motor, to move up or down in the shaft 210.

The first capturing device 20 is a camera module and is received in the cage 10, suspended to the ceiling 11. The first capturing device 20 is configured for capturing images of the inner room 14.

The second capturing device 30 is a camera module and is set on the wall 220, outside the cage 10. The second capturing device 30 is configured for capturing images of the waiting area 231.

The inner control panel 40 is attached on the sidewall 13. The inner control panel 40 includes a number of number buttons 41. People (not shown) in the inner room 14 can input command to the elevator system 100 by the number buttons 41 of the inner control panel 40.

The outer control panel 50 is attached on the wall 220 in front of the waiting area 231. The outer control panel 50 includes an up button 51 and a down button 52. People waiting in the waiting area 231 control the cage 10 to move up or move down by the up button 51 or down button 52.

The control module 60 is electrically connected to the first capturing device 20, the second capturing device 30, the inner control panel 40, and the outer control panel 50. When people press the up button 51 or the down button 52 of the outer control panel 50, the control module 60 controls the first capturing device 20 to capture the image of the inner room 14 and the second capturing device 30 to capture the images of the waiting area 231.

The alarm device 70 is set on the wall 220 and is electrically connected to the control module 60. The alarm device 70 is configured for warning the people waiting at the waiting area 231 that the cage 10 will not stop at this floor.

When the cage 10 is driven to move upward, if the control module 60 detects the up button 51 is pressed by a passenger located at the floor 230, the control module 60 controls the second capturing device 30 to capture the images of the waiting area 231 before the cage 10 arrives at the floor. The control module 60 analyzes the images and determines if any people at the waiting area 231. If no people are at the waiting area 231 (if all of the people leave the waiting area 231 after pressing the up button 51), the control module 60 controls the cage 10 not to stop at the floor 230.

Otherwise, if the control module 60 detects the up button 51 is pressed and at the least one person is waiting at the waiting area 231, the control module 60 controls the first capturing device 20 to capture images of the inner room 14. The control module 60 analyzes the images and determines if there is enough room for the at least one waiting passenger. If there is not enough room for any more passengers, the control module 60 controls the cage 10 not to stop at the floor 230. At the same time, the control module 60 activates the alarm device 70 to warn the waiting people that the cage 10 will not stop at the floor 230. In this embodiment, there are two people waiting at the waiting area 231, the control module 60 determines whether or not there is enough room for at least one waiting person.

If the control module 60 determines there is enough room for at least one person, waiting at the waiting area 231, the control module 60 controls the cage 10 to stop at the floor 230.

When the cage 10 is driven to move downward, controls are essentially similar to the controls when the cage 10 moves upward and therefore details thereof are omitted.

Furthermore, the elevator system 100 includes a first weight sensor 80 and a second weight sensor 90. The first weight sensor 80 and the second weight sensor 90 are electrically connected to the control module 60. The first weight sensor 80 is positioned at the cage floor 12 for detecting a load of the cage 10. The second weight sensor 90 is positioned at the waiting area 231 for detecting the weight of the people waiting at the waiting area 231.

After the control module 60 determines there is enough room to receive the at lease one passenger, the control module 60 further determines whether or not the cage 10 can load the people according to detecting results of the first weight sensor 80 and the second weight sensor 90. If the control module 60 determines the cage 10 cannot load at least one person waiting at the waiting area 231, the control module 60 controls the cage 10 not to stop at the floor 230.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An elevator system, comprising:
a cage comprising an inner room;
a first capturing device configured for capturing an image of the inner room;
a second capturing device configured for capturing an image of a waiting area outside the cage; and
a control module in communication with the first capturing device and the second capturing device, the control module configured for receiving the images output from the first capturing device and the second capturing device and determining whether or not there is any passenger located at the waiting area based on the images from the second capturing device and whether or not there is enough room to receive the passenger at the waiting area based on the images from the first and second capturing devices; the control module also configured for controlling the cage to stop or not to stop according to the determination.

2. The elevator system of claim 1, wherein if there is no one passenger in the image captured by the second capturing device, the control module controls the cage not to stop.

3. The elevator system of claim 2, wherein if there is passenger in the image captured by the second capturing device, the control module determines whether or not there is enough room in the inner room to receive the passenger at the waiting area; if there is enough room to receive the passenger at the waiting area , the control module controls the cage to stop; otherwise, the control module controls the cage not to stop.

4. The elevator system of claim 1, further comprising an alarm device electrically connected to the control device, the alarm device configured for reminding the people waiting at the waiting area that the cage will not stop.

5. The elevator system of claim 1, further comprising a first weight sensor and a second weight sensor; the first weight sensor and the second weight sensor are electrically connected to the control module; the first weight sensor configured for detecting a load of the cage, and the second weight sensor configured for detecting the weight of the people waiting at the waiting area; wherein if the control module determines there is enough room to receive the passenger at the waiting area, the control module determines whether or not the cage can load the people at the waiting area according to detecting results of the first weight sensor and the second weight sensor; if the control module determines the cage can load the passenger waiting at the waiting area, the control module controls the cage to stop; otherwise, the control module controls the cage not to stop.
